(19) United States
(12) Patent Application Publication
(10) Pub. No.: US 2007/0247566 A1
(43) Pub. Date: Oct. 25, 2007

(54) LIQUID CRYSTAL DISPLAY MODULE

(76) Inventor: Dae Ho Choo, Seongnam-si (KR)

Correspondence Address: Frank Chau, Esq.;F. CHAU & ASSOCIATES, LLC, 130 Woodbury Road, Woodbury, NY, 11797, US

(21) Appl. No.: 11/567,496

(22) Filed: Dec. 6, 2006

(30) Foreign Application Priority Data
Apr. 19, 2006 (KR) 2006-0035181

(51) Int. Cl. G02F 1/1335

(52) U.S. Cl. 349/96

(57) ABSTRACT

A liquid crystal display module comprises a liquid crystal display (LCD) panel, a light source unit that generates light, a wire grid polarizing plate that selectively transmits and reflects light generated from the light source unit, and a light converting unit that can be formed on the wire grid polarizing plate and converts light reflected from the wire grid polarizing plate to transmit the wire grid polarizing plate.

### CROSS-REFERENCE TO RELATED APPLICATIONS

The present application claims priority to Korean Patent Application No. 10-2006-0035181, filed on Apr. 19, 2006, the disclosure of which is incorporated by reference in its entirety

### BACKGROUND OF THE INVENTION

1. Technical Field

The present disclosure relates to a liquid crystal display module. More particularly, the present disclosure relates to a liquid crystal display module capable of obtaining high brightness.

2. Discussion of the Related Art

Liquid crystal display (LCD) devices have gained widespread popularity in various fields due to attractive features such as light weight, thin., and low-power consumption, etc. The LCD devices display images by applying an electric field to a liquid crystal material having an anisotropy dielectric constant. The liquid crystal material is interposed between two substrates, a thin film transistor (TFT) substrate and a countering substrate. By adjusting the strength of the electric field the amount of light transmitted through the two substrates can be adjusted.

Since the LCD device is not self-emissive, the LCD device needs a light source unit supplying light to a LCD panel.

Light generated in the light source unit is incident on the LCD panel through a polarizer located in the back surface of the LCD panel. The polarizer polarizes the light but also reduces the intensity of the light passing therethrough (e.g. reduction of about 43%). Thus, a brightness enhancement film is interposed between a polarizer and a light source unit To compensate for the reduced brightness. However, the brightness enhancement film can be expensive, and an additional process of attaching the brightness enhancement film is required.

### SUMMARY OF THE INVENTION

Exemplary embodiments of the present invention provide a liquid crystal display module capable of obtaining high brightness.

In an exemplary embodiment of the present invention a light crystal display (LCD) module comprises an LCD panel, a light source unit that generates light used for displaying an image, a wire grid polarizing plate that selectively transmits and reflects light generated from the light source unit and a light converting unit that is formed on the lower portion of the wire grid polarizing plate and converts light reflected from the wire grid polarizing plate to transmit the wire grid polarizing plate.

The light source unit may be a cold cathode fluorescent lamp (CCFL) or an external electrode fluorescent lamp (EE FL).

The light converting unit comprises a light converting plate that converts Y-directional polarized light into X, Y-double directional polarized light and a reflecting sheet that reflects light reflected from the wire grid polarizing plate back to the wire grid polarizing plate.

Alternatively, the light source unit may be formed of an upper light-emitting type electroluminescent (EL) element.

According to an aspect of the invention, the light converting plate is formed between the reflecting sheet and the wire grid polarizing plate to refract light reflected from the wire grid polarizing plate and light reflected from the reflecting sheet. The light converting plate is formed of a material having a refraction index more than that of the air and differing from that of the wire grid polarizing plate.

The wire grid polarizing plate comprises a transparent substrate, a light reflecting layer disposed between transmission holes formed on the transparent substrate, and an insulating film formed on the transparent substrate to cover the light reflecting layer and the transparent substrate.

The light reflecting layer is formed of a metal, for example, Al, Cr, Mo, Ag, Cu, Au or an opaque polymer material.

The transmission hole has width less than the wavelength of a visible ray.

Preferably, the transmission hole has width of about 100˜300 nm.

The light reflecting layer has substantially the same width as that of the transmission hole. Alternatively, the light reflecting layer has a width about 20% greater than that of the transmission hole. The light reflecting layer is formed of one type of stripe, curve, chevron, or matrix. The light reflecting layer of the wire grid polarizing plate can be formed by a laser beam radiation method or a photolithography method.

According to another aspect of the invention, an LCD panel comprises a thin film transistor (TFT) substrate having a plurality of TFTs formed on a lower substrate, a countering substrate facing the TFT substrate., and a liquid crystal layer interposed between the TFT substrate and the countering substrate.

The LCD panel further comprises an upper phase difference film formed on the front side of the countering substrate and a lower phase difference film formed on the back side or the front side of the TFT substrate. The wire grid polarizing plate can either be affixed to the lower phase difference film or be spaced apart from the lower phase difference film.

### BRIEF DESCRIPTION OF THE DRAWINGS

Exemplary embodiments of the present invention can be understood in more detail from the following descriptions taken in conjunction with the accompanying drawings, in which:

FIG. 1 is a cross-sectional view showing a liquid crystal display module according to an exemplary embodiment of the present invention;

FIG. 2 is a cross-sectional view showing a liquid crystal display module according to an exemplary embodiment of the present invention;

FIGS. 3a and 3b are graphical views showing a wire grid polarizing plate o FIGS. 1 and 2, respectively;

FIGS. 4a to 4d are graphical views showing a method of manufacturing a light reflecting layer of the wire grid polarizing plate according to an exemplary embodiment of the present invention;

FIG. 5 is a graphical view showing a manufacturing apparatus used in the method of manufacturing the light reflecting layer of FIG. 4;

FIGS. 6a to 6d are graphical views showing a method of manufacturing a light reflecting layer of the wire grid polarizing plate according to an exemplary embodiment of the present invention;

FIG. 7 is a graphical view showing a manufacturing apparatus used in the method of manufacturing the light reflecting layer of FIG. 6;

FIG. 8 is a graphical view showing a variable polarization of light in the liquid crystal display module of FIG. 1;

FIG. 9 is a cross-sectional view showing a liquid crystal display module according to an exemplary embodiment of the present invention;

FIG. 10 is a cross-sectional view showing a liquid crystal display module according to an exemplary embodiment of the present invention,

FIGS. 11a and 11b are cross-sectional view illustrating a location of lower retardation films of FIGS. 9 and 10, respectively;

FIG. 12 is a cross-sectional view showing a liquid crystal display module according to an exemplary embodiment of the present invention;

FIG. 13 is a cross-sectional view showing a liquid crystal display module according to an exemplary embodiment of the present invention;

FIG. 14 is a cross-sectional view showing a liquid crystal display module according to an exemplary embodiment of the present invention; and

FIG. 15 is a cross-sectional view showing a liquid crystal display module according to an exemplary embodiment of the present invention.

### DESCRIPTION OF EXEMPLARY EMBODIMENTS

Exemplary embodiments of the invention are described more fully hereinafter with reference to the accompanying drawings, in which embodiments of the invention are shown This invention may, however, be embodied in many different forms and should not be construed as limited to the embodiments set forth herein.

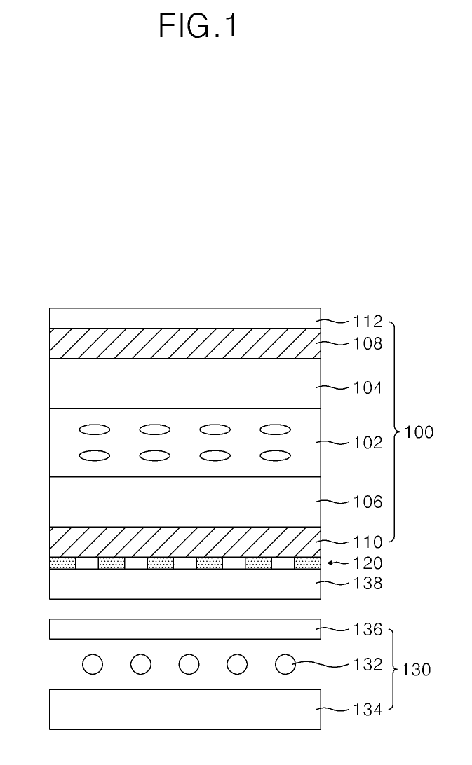

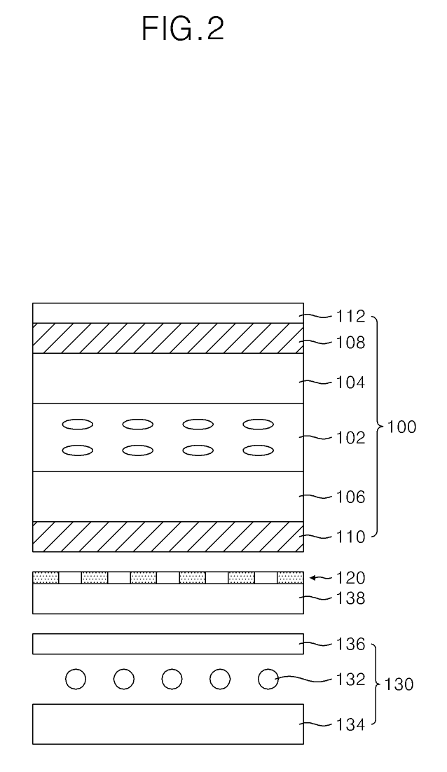

FIGS. 1 and 2 are cross-sectional views showing a liquid crystal display air module according to an exemplary embodiment of the present invention.

Referring to FIGS. 1 and 2, a liquid crystal display module comprises a liquid crystal display (LCD) panel 100, a backlight unit 130 supplying light to the LCD panel 100, a wire grid polarizing plate 120 interposed between the LCD panel 100 and the backlight unit 130: and a light converting plate 138 formed on the lower portion of the wire grid polarizing plate 120.

The backlight unit 130 comprises a light source unit 132: a diffusing sheet 136 diffusing light coming from the light source unit 132, and a reflecting sheet 134 formed below the lower portion of the light source unit 132.

The light source unit 132 may be a cold cathode fluorescent tamp (CCFL) or an external electrode fluorescent tamp (EEFL). The light source unit 132 generates light and emits the light toward the diffusing sheet 136.

The reflecting sheet 134 is formed of a material with a high reflectivity and reflects the light proceeding in an opposing direction against the diffusion sheet 136 toward the diffusing sheet 136, and thus the reflecting sheet 134 may reduce a loss of light.

The diffusing sheet 136 directs the light incident from the light source unit 132 to the front surface of the LCD panel 100 and diffuses the light so as to uniformly distribute the light. Then, the diffusing sheet 136 delivers the uniformly diffused light to the LCD panel 100. The diffusing sheet 136 may be a film formed of a transparent resin coated with a member for light diffusion on both sides of the transparent resin.

The LCD panel 100 comprises a thin film transistor (TFT) substrate 106, a countering substrate 104 facing the TFT substrate 106 a liquid crystal layer 102 interposed between the countering substrate 104 and the TFT substrate 106, upper and tower retardation films 108, 110 attached to the outer surfaces of the countering substrate 104 and the TFT substrate 106, respectively, and a film type polarizer 112 attached to the whole surface of the upper retardation film 108.

The countering substrate 104 may comprise a black matrix (BM) preventing light leakage, a plurality of color filters, a common electrode and an upper alignment layer deposited on the common electrode for alignment of the liquid crystal layer.

The TFT substrate 106 is provided with a TFT array (not shown) comprising a plurality of gate lines, a plurality of data lines intersecting the gate lines, a plurality of TFTs formed at an intersected portion of each of the data lines and each of the gate lines, a plurality of pixel electrodes connected to the TFT, and a lower alignment layer deposited on the pixel electrodes for alignment of the liquid crystal layer.

The upper and lower phase difference films 108, 110 are attached to the countering substrate 104 and the TFT substrate 106, respectively, so as to compensate phase difference resulting from a difference of a polarization of the liquid crystal layer in accordance with a variation of a viewing angle caused by birefringence.

The film type polarizer 112 is preferably an iodine-based film. The polarizer 112 transmits light parallel with its own transmission axis and reflects light perpendicular to the transmission axis. The polarizer 112 has a polarizing direction perpendicular to that of the wire grid polarizing plate 120 when the liquid crystal layer 102 is a TN mode (i.e. a twisted angle of 90°).

As shown in FIG. 1, the wire grid polarizing plate 120 is affixed to the lower phase difference film 110 or, as shown in FIG. 2, the wire grid polarizing plate 120 is spaced apart from the lower phase difference film 110 by a given interval.

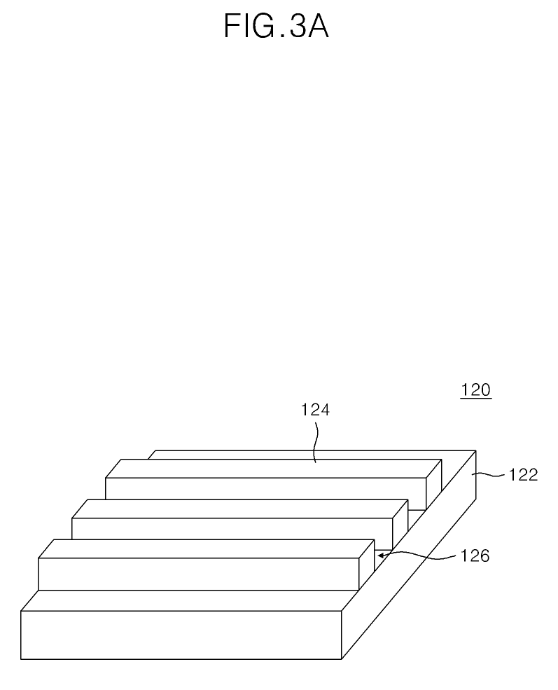

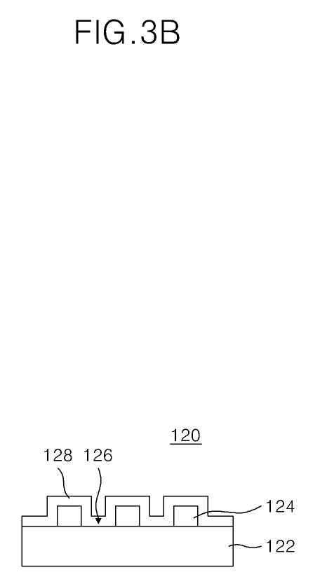

Referring to FIG. 3a the wire grid polarizing plate 120 comprises a transparent substrate 122 and a plurality of light reflecting layers 124 formed on the transparent substrate 122.

The transparent substrate 122 may be formed of a material for example, a glass.

The light reflecting layer 124 may be formed on the transparent substrate 122 in one type of stripe, curve, chevron, or matrix, etc. using a metal that may include, for example, Al, Cr, Mo, Ag, Cu and/or Au or an opaque polymer material. The light reflecting layers 124 are spaced apart from each other with a transmission hole 126 disposed therebetween. At this time, the transmission hole 126 is formed with a width of about 100˜300 nm, preferably, 120 nm, less than the wavelength of a blue color being a minimum wavelength in a range of a visible ray. The light reflecting layer 124 is formed with the same width as that of the transmission hole 126. Alternatively, the light reflecting layer 124 is formed with a width more than that of the transmission hole 126 by about 20%. Further, an insulating film 128 may be formed for covering the light reflecting layer 124 as shown in FIG. 3b so as to protect the light reflecting layer 124.

The light reflecting layer 124 is formed by a photolithography method, a printing method, or a laser radiation method suitable for a micro process.

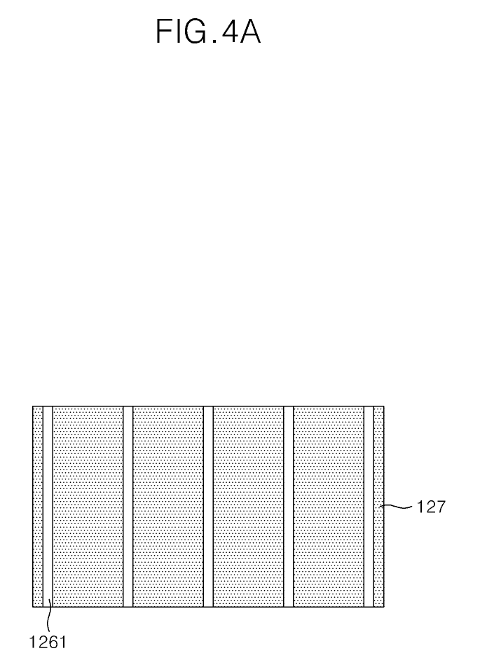

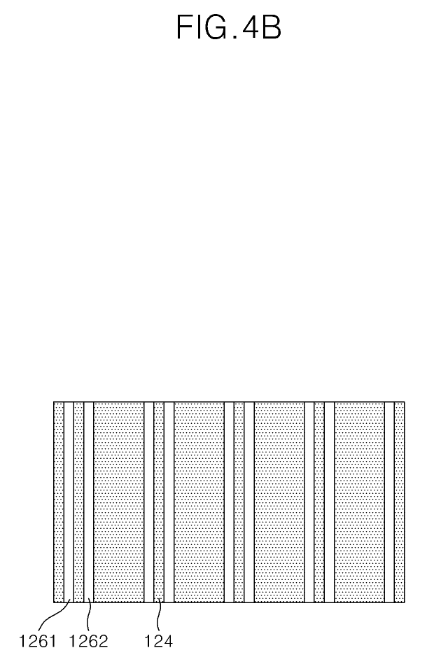

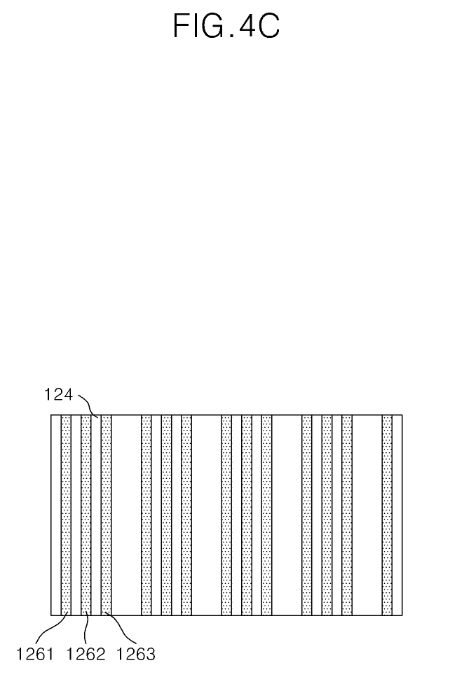

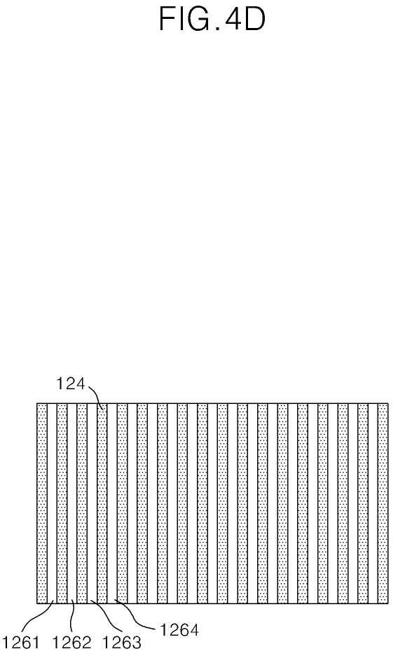

A method of manufacturing the light reflecting layer 124 using a laser radiation method will be described with reference to FIG. 4.

Referring to FIG. 4, a first transmission hole 1261 exposing the transparent substrate 122 is formed by heating and evaporating an opaque film 127 formed on the transparent substrate 122 by a laser radiation apparatus (not shown). Then, after the laser radiation apparatus is shifted by the width of the light reflecting layer 124 to be formed later, as shown in FIG. 4b, a second transmission hole 1262 exposing the transparent substrate 122 is formed by heating and evaporating the opaque film 127. At this time., the light reflecting layer 124 is formed between the first and second transmission holes 1261, 1262. Then, after the laser radiation apparatus is shifted by the width of the light reflecting layer 124 to be formed later, as shown in FIG. 4c, a third transmission hole 1263 exposing the transparent substrate 122 is formed by heating and evaporating the opaque film 127. At this time, the light reflecting layer 124 is formed between the second and third transmission holes 1262. 1263. Then, after the laser radiation apparatus is shifted by the width of the light reflecting layer 124 to be formed later as shown in FIG. 4d, a fourth transmission hole 1264 exposing the transparent substrate 122 is formed by heating and evaporating the opaque film 127. The light reflecting layer 124 is formed between the third and fourth transmission holes 1263, 1264.

In this way, a plurality of the light reflecting layers 124 may be formed on the transparent substrate 122 by repeating the above process.

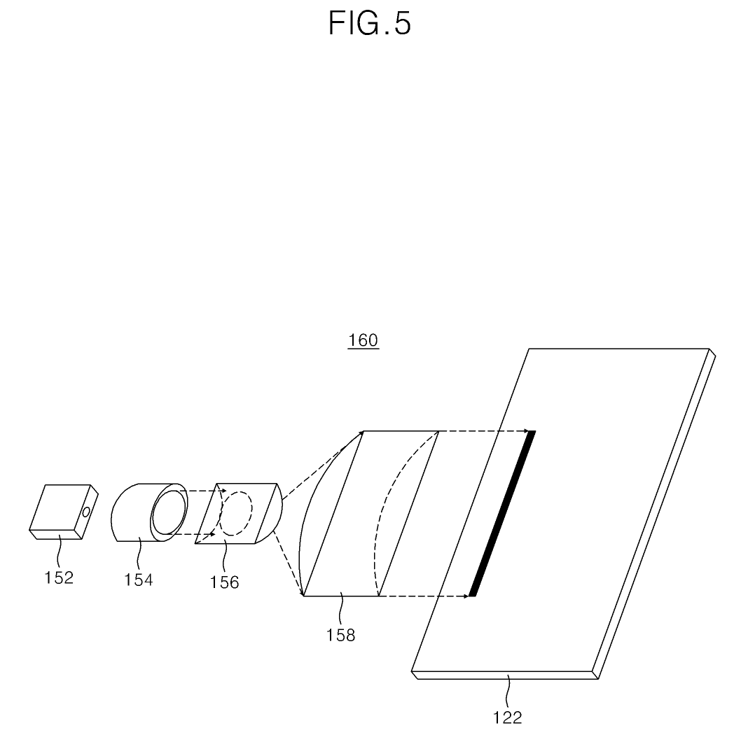

Referring to FIG. 5, a laser radiation apparatus 160 for forming the light reflecting layer 124 comprises first and second light expanding portions 154, 156 disposed between a laser light source unit 152 and the transparent substrate 122 and a cylinder lens 158.

The laser light source unit 152 generates a laser light by means of amplification and oscillation using emission phenomenon of inner energy of material. The laser light source unit 152 may use, for example, a UV laser, a CO₂ laser or a YAG laser.

The first light expanding portion 154 expands and uniformly distributes a laser light, and then converts it into a laser beam in the direction of a major axis.

The second light expanding portion 156 expands and uniformly distributes the laser light converted in the first light expanding portion 154, and then converts it into a laser beam in the direction of a major axis it should be noted that the first and second light expanding portions 154, 156 serve to illustrate exemplary optical accessories usable for the present embodiment of the invention. Other like accessories known to one skilled in the art that can perform the same or similar functions are within contemplation for use herein.

The cylinder lens 158 has an incident surface receiving light emitted from the second light expanding portion 156 and having a planar shape, and an emission surface having a convex shape. The cylinder lens 158 converts the emitted light into light parallel with an optical axis and emits one laser light toward the transparent substrate 122.

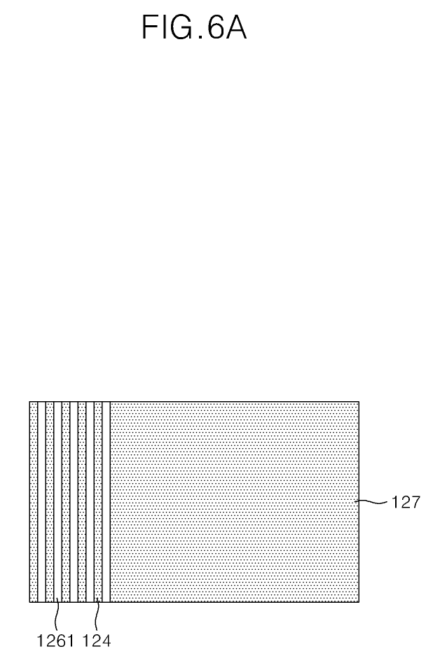

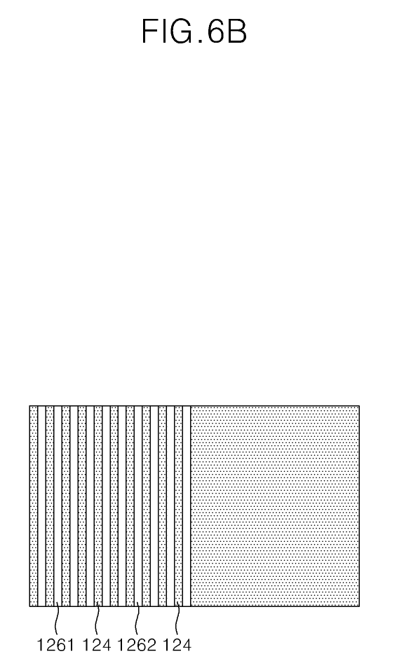

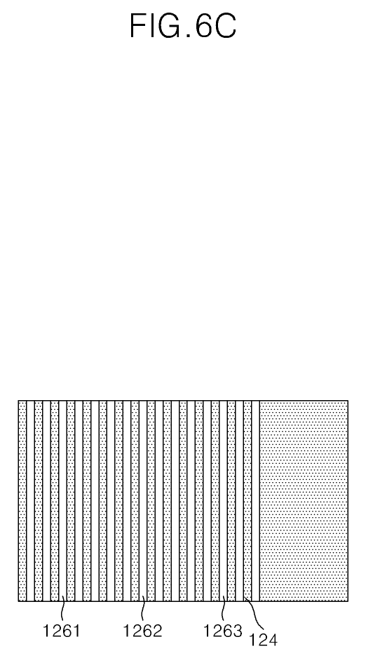

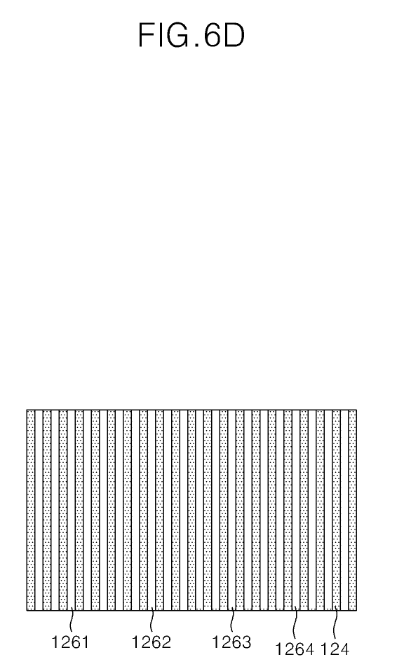

Referring to FIG. 6a, a plurality of first transmission holes 1261 exposing the transparent substrate 122 (see FIG. 5) and a plurality of the light reflecting layers 124 interposed between a plurality of the first transmission holes 1261 are formed by heating and evaporating the opaque film 127 formed on the transparent substrate 122 by a laser radiation apparatus (not shown). Then, the laser radiation apparatus is shifted by a width of the light reflecting layers to be formed later and that of a plurality of second transmission holes interposed between the light reflecting layers 124. As shown in FIG. 6b, the laser radiation apparatus shifted forms a plurality of second transmission holes 1262 exposing the transparent substrate 122 and a plurality of the light reflecting layers 124 interposed between the second transmission holes 1262 by heating and evaporating the opaque film 127. Then, the laser radiation apparatus is shifted by a width of the light reflecting layers 124 to be formed later and that of a third transmission holes 1263 interposed between the light reflecting layers 124. As shown in FIG. 6c, the laser radiation apparatus shifted forms a plurality of third transmission holes 1263 exposing the transparent substrate 122 and a plurality of the light reflecting layers 124 interposed between the third transmission holes 1263 by heating and evaporating the opaque film 127. The laser radiation apparatus is shifted by a width of the light reflecting layers 124 to be formed later and that of fourth transmission holes 1264 interposed between the light reflecting layers 124. As shown in FIG. 6d, the laser radiation apparatus shifted forms a plurality of fourth transmission holes 1264 exposing the transparent substrate 122 and a plurality of the light reflecting layers 124 interposed between the fourth transmission holes 1264 by heating and evaporating the opaque film 127. By repeating the above process, a desired number of the light reflecting layers 124 may be formed on the transparent substrate 122. Alternatively, the transmission holes 126 and the light reflecting layers 124 may be simultaneously formed by a single process.

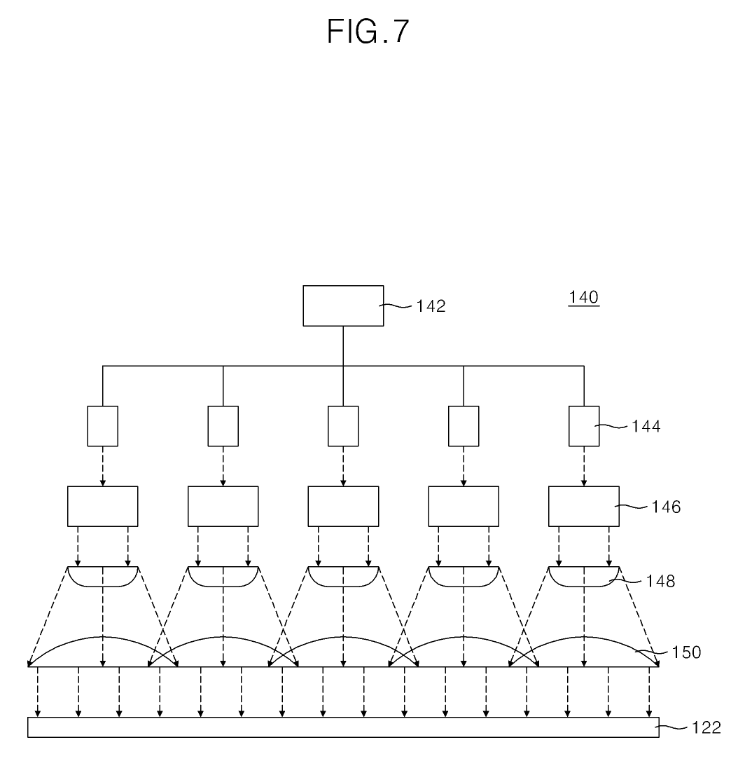

Referring to FIG. 7 a laser radiation apparatus 140 for simultaneously forming the light reflecting layers 124 comprises a plurality of first and second light expanding portions 144, 146 interposed between a laser light source unit 142 and the transparent substrate 122, and a plurality of first and second cylinder lens 148, 150.

The laser light source unit 142 generates a laser beam by means of amplification and oscillation using emission phenomenon of inner energy of a material. The laser light source unit 142 may use; for example, a UV laser, a CO₂ laser or a YAG laser.

The first light expanding portion 144 expands and uniformly distributes a laser light, and firstly converts it into a laser light in the direction of a major axis.

The second light expanding portion 146 expands and uniformly distributes the laser light converted in the first light expanding portion 144, and secondly converts it into a laser light in the direction of a major axis.

The first cylinder lens 148 has an incident surface receiving light output from the second light expanding portion 146 and having a planar shape, and an emission surface having a convex shape. The first cylinder lens 148 converts the emitted light into light parallel with an optical axis and emits it. The second cylinder lens 150 converts the emitted light into a light parallel with an optical axis and emits it toward the transparent substrate 122. At this time, the laser light being emitted through a plurality of the second cylinder lens 150 may be a point light, a slit beam or an anisotropic line beam, etc.

The wire grid polarizing plate 120 formed by the above apparatus and method transmits light parallel with its own transmission axis and reflects light perpendicular to the transmission axis. In other words, the wire grid polarizing plate 120 transmits a linearly polarized light, for example, light in X axis, having the same oscillating direction as that of the transmission hole 126 among light incident on the wire grid polarizing plate 120. Further, the wire grid polarizing plate 120 transmits a linearly polarized light, for example, light in Y axis, having the direction perpendicular to the transmission hole 126 among light incident on the wire grid polarizing plate 120.

The light converting portion 138 may be formed on the back surface of the wire grid polarizing plate 120 or on front or back surfaces of the diffusing sheet 136 or on the front surface of the reflecting sheet 134. The light converting portion 138 has a refraction index different from that of adjacent elements upward or downward and is formed of a material with a refraction index more than that of the air The light converting portion 138 refracts light reflected from the wire grid polarizing plate 120 and light reflected from the reflecting sheet 134. The refracted light is converted to transmit the wire gird polarizing plate 120.

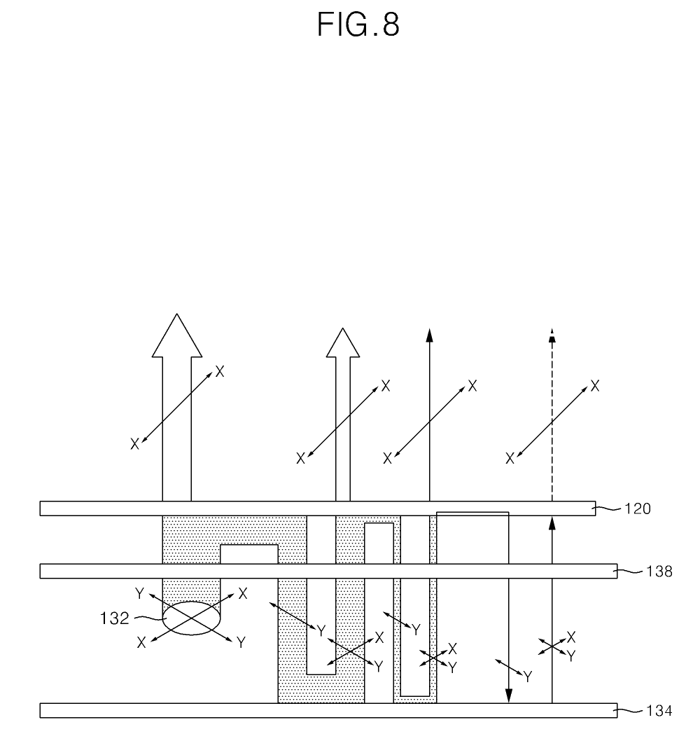

Referring to FIG. 8, a X-directional polarized light that is parallel with the transmission axis of the wire grid polarizing plate 120 among light generated from the light source unit 132 passes through the wire grid polarizing plate 120 and is incident on the LCD panel 100.

Meanwhile, a Y-directional polarized light that is not parallel with the transmission axis of the wire grid polarizing plate 120 among light generated from the light source unit 132 is reflected. The Y-directional polarized light reflected by the wire grid polarizing plate 120 is refracted by the light converting plate 138 and is incident on the reflecting sheet 134. The Y-directional polarized light incident on the reflecting sheet 134 is reflected again and is incident on the light converting plate 138. The Y-directional light incident on the light converting plate 138 is refracted again and converted into X,Y double directional polarized light that comprises both the X-directional polarized light (X) and the Y-directional polarized light (Y). The X-directional polarized light (X) that is parallel with the transmission axis of the wire grid polarizing plate 120 among the mixed light passes through the wire grid polarizing plate 120 and the Y-directional polarized light (Y) perpendicular to the transmission axis of the wire grid polarizing plate 120 is reflected. The Y-directional polarized light reflected repeats the above process. In this way, light is recycled between the wire grid polarizing plate 120 and the reflecting sheet 134, and thus brightness may be enhanced by more than 30% and the transmission rate of the polarization may be enhanced by more than 80% as well.

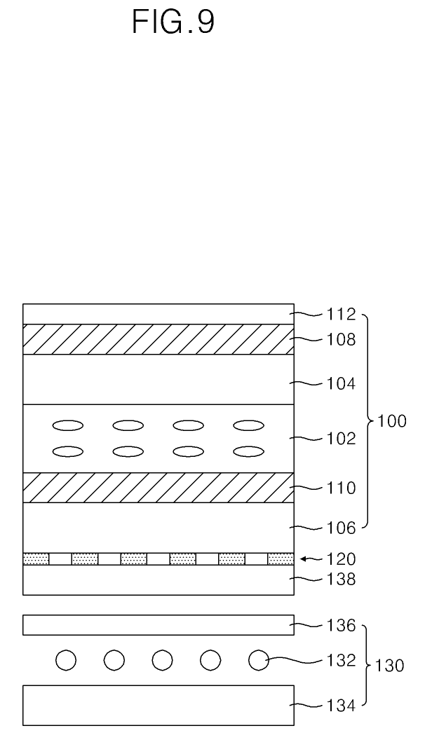

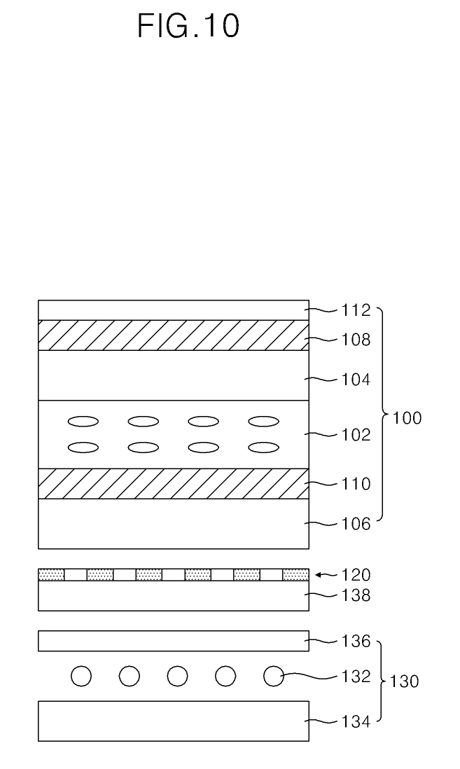

FIGS. 9 and 10 are cross-sectional views showing a liquid crystal display module according to an exemplary embodiment of the present invention.

Referring to FIGS. 9 and 10 the liquid crystal display module comprises the same elements as those of FIG. 1 except that the lower phase difference film is formed on the TFT substrate. The wire grid polarizing plate 120 transmits light parallel with its own transmission axis and reflects light perpendicular to the transmission axis. As shown in FIG. 9, the wire grid polarizing plate 120 is affixed to the back surface of the TFT substrate 106. The wire grid polarizing plate 120 is formed by forming the light reflecting layer and the insulating layer on the back surface of the TFT substrate 106 without a separate transparent substrate. As a result, the thickness and weight of the liquid crystal display module may be reduced. Alternatively as shown in FIG. 10, the wire grid polarizing plate 120 may be spaced apart from the back surface of the TFT substrate 106 by a desired interval.

The lower phase difference film 110 is formed of a RMM (Reactive Mesogen Mixture) material on the TFT substrate 106 so as to compensate phase difference resulting from a difference of the polarization of the liquid crystal layer based on a viewing angle by birefringence.

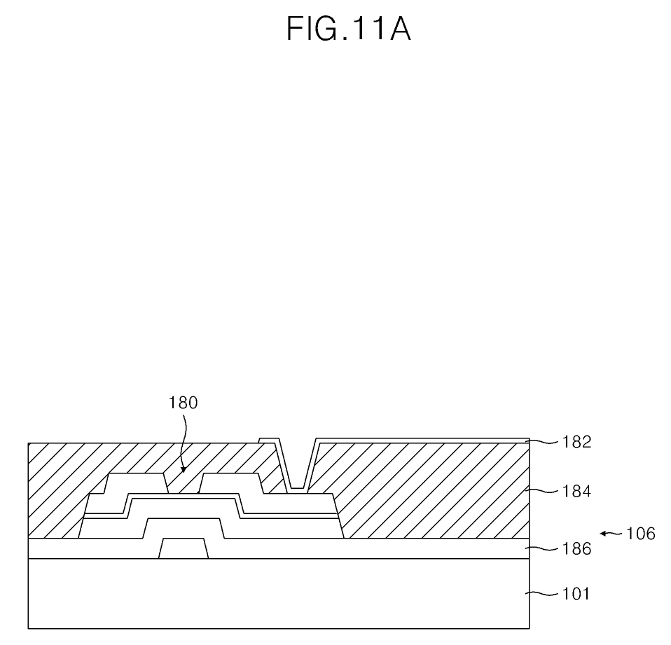

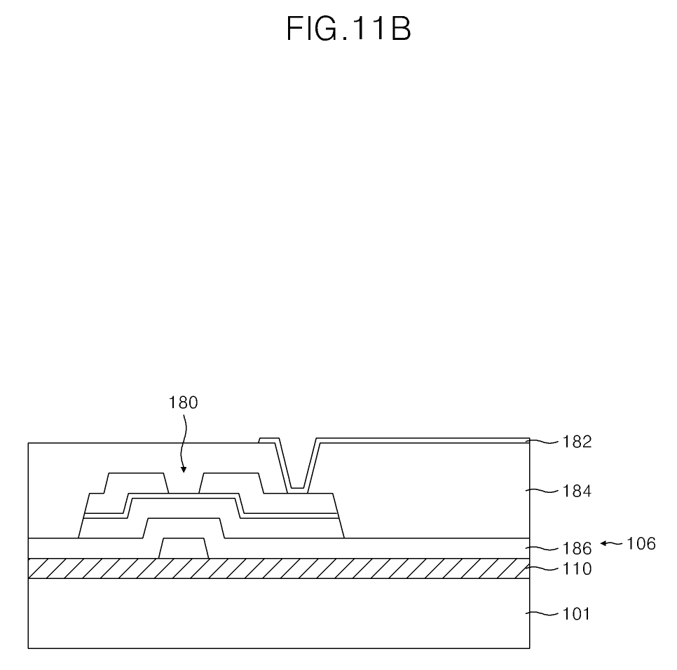

In other words, as shown in FIG. 11a, the lower phase difference film 110 is disposed between a thin film transistor (TFT) 180 and a pixel electrode 182 so as to cover the TFT 180 and functions as a protective film 184 as well.

Alternatively, as shown in FIG. 11b the lower phase difference film 110 may be disposed between the gate electrode of the TFT 180 and the lower substrate 101.

Alternatively, the lower phase difference film 110 may be disposed between the gate of the TFT 180 and an active layer (not shown) and functions as a gate insulating film 186 as well.

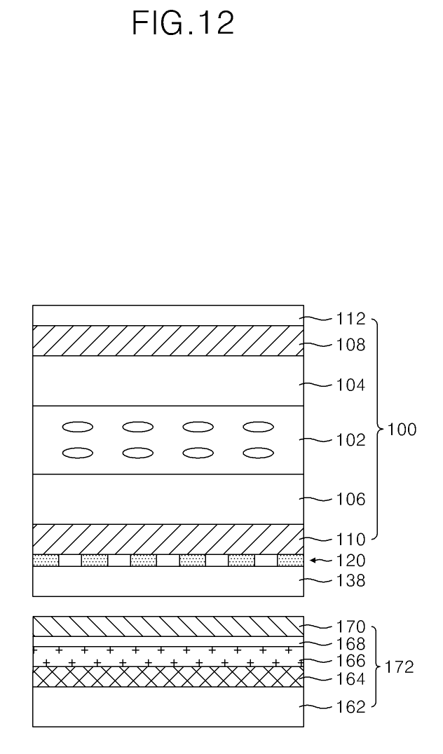

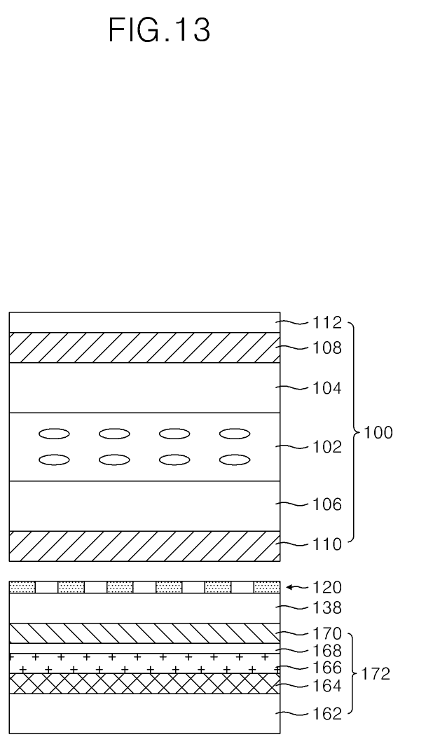

FIGS. 12 and 13 are cross-sectional views showing the liquid crystal display module according to an exemplary embodiment of the present invention.

Referring to FIGS. 12 and 13, the liquid crystal display module comprises the same elements as those of FIG. 10, except that the backlight unit is formed using an electroluminescent (EL) element. Therefore, the detailed description thereof will be omitted.

An electroluminescence (EL) type backlight unit 172 supplies light to the LCD panel 100. The EL type backlight unit 172 comprises a light source substrate 162, a reflecting electrode 164 formed on the light source substrate 162 a transmission electrode 168 intersecting the reflecting electrode 164, and an organic thin film layer 166 interposed between the reflecting electrode 164 and the transmission electrode 168. Further, the EL type backlight unit 172 may comprise a separate protective layer 170 formed on the transmission electrode 168 so as to prevent damages of the EL type backlight unit 172.

The light source substrate 162 may be formed of a glass material or a plastic material with a flexible property.

The reflecting electrode 164 is formed on the light source substrate 162 and receives a driving signal for injecting electrons or holes. The reflecting electrode 164 uses a metal of a high reflectivity or an alloy of two or more metals so as to reflect light generated from the organic thin film layer 166,

The organic thin film layer 166 comprises a hole injection layer, a hole carry layer, a light emitting layer, an electron carry layer, and an electron injection layer sequentially deposited on the reflecting electrode 164.

The transmission electrode 168 is formed on the organic thin firm layer 166 and receives a driving signal for injecting holes or electrons. The transmission electrode 168 is formed of a transparent conductive material, for example, indium tin oxide (ITO) or indium zinc oxide (IZO), to transmit a visible ray generated from the organic thin film layer 166 to outside.

The EL type backlight unit 172 emits electrons and holes when the reflecting electrode 164 and the transmission electrode 168 receive a driving signal, and the holes and electrons emitted from the reflecting electrode 164 and the transmission electrode 168 are recombined in the organic thin film layer 166, thereby generating a visible ray.

The EL type backlight unit 172 is a flat light-emitting device, and as such the light is uniform within an emitting area without the need for a separate optical sheet such as a diffusion sheet, etc. Further, the light-emitting cells in the EL type backlight unit 172 may correspond to the pixels of the LCD panel (in other words, one light-emitting cell for every one pixel). Thus, the gray levels can be controlled like a pixel of the LCD panel.

The wire grid polarizing plate 120 transmits light parallel with its own transmission axis and reflects light perpendicular to the transmission axis. As shown in FIG. 12, the wire grid polarizing plate 120 is affixed to the back surface of the lower portion of the TFT substrate 106. The wire grid polarizing plate 120 is formed by forming the light reflecting layer and the insulating layer on the back surface of the TFT substrate 106 without a separate transparent substrate. As a result, the thickness and weight of the liquid crystal display module may be reduced.

Alternatively, as shown in FIG. 13, the wire grid polarizing plate 120 may be spaced apart from the back surface of the TFT substrate 106 by a desired interval and is formed independently.

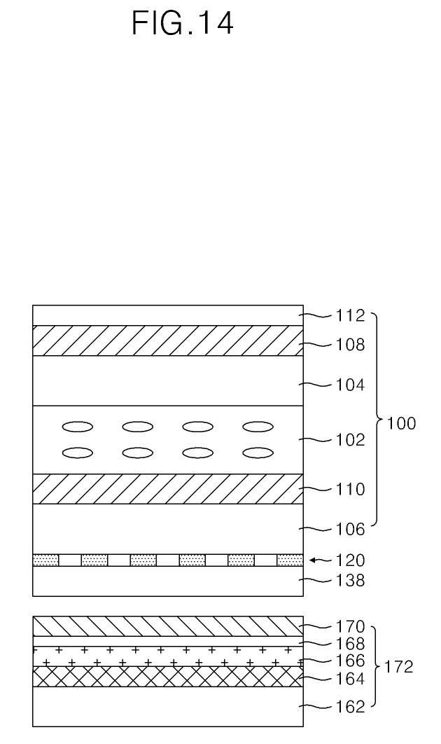

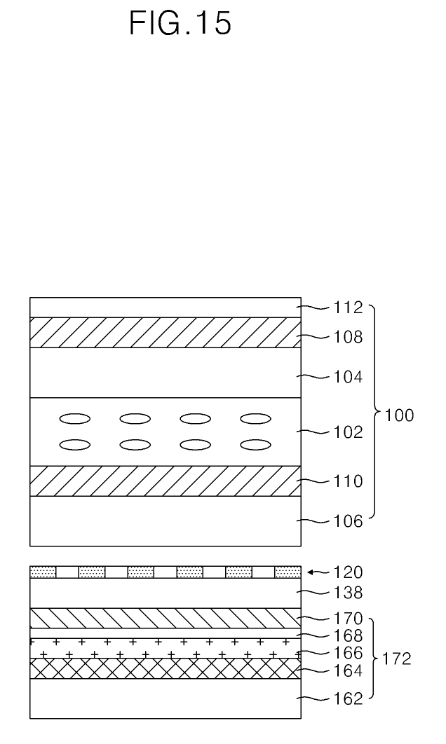

FIGS. 14 and 15 are cross-sectional views showing the liquid crystal display module according to an exemplary embodiment of the present invention.

FIGS. 14 and 15 comprise the same elements as those of FIGS. 12 and 13 except that the lower phase difference film 110 is formed on the TFT substrate 106 compared to the liquid crystal display module of FIGS. 12 and 13. The lower phase difference film 110 is formed of a RMM (Reactive Mesogen Mixture) on the TFT substrate 106. The lower phase difference film 110 is formed between the TFT and the pixel electrode to function as a protective film. Further, the lower phase difference film 110 is formed between the gate electrode of the TFT and an active layer to function as a gate insulating film. Alternatively, the lower phase difference film 110 may be formed between the gate electrode and the lower portion of the TFT substrate 106. As shown in FIG. 14, the wire grid polarizing plate 120 is affixed to the back surface of the TFT substrate 106. At this time, the wire grid polarizing plate 120 is formed by forming the light reflecting layer and the insulating layer on the back surface of the TFT substrate 106 without a separate transparent substrate. As a result, the thickness and weight of the liquid crystal display module may be reduced.

Alternatively, as shown in FIG. 15, the wire grid polarizing plate 120 may be spaced apart from the back surface of the TFT substrate 106 by a desired interval and is formed independently,

Meanwhile, the wire grid polarizing plate 120 may be formed in the TFT substrate. For example, if the wire grid polarizing plate 120 is formed on the whole surface of the lower portion of the TFT substrate 106, the light converting portion is formed on the back surface of the TFT substrate 106.

According to at least one embodiment of the present invention, the liquid crystal display module can dispense with a separate brightness enhancement film since the liquid crystal display module selectively transmits and reflects light generated from the light source unit using the wire grid polarizing plate. Accordingly, the liquid crystal display module may enhance brightness and a polarizing transmission rate without a separate brightness enhancement film. Although the exemplary embodiments of the present invention have been described herein with reference to the accompanying drawings, it is to be understood that the present invention should not be limited to those precise embodiments and that various other changes and modifications may be affected therein by one of ordinary skill in the related art without departing from the spirit or scope of the invention. All such changes and modifications are intended to be included within the scope of the invention as defined by the appended claims.

What is claimed is:

1. A liquid crystal display (LCD) module comprising:
an LCD panel;
a light source unit that generates light;
a wire grid polarizing plate that selectively transmits and reflects light generated from the light source unit; and
a light converting unit that converts light reflected from the wire grid polarizing plate.

2. The liquid crystal display module of claim 1 wherein the light source unit is a cold cathode fluorescent lamp (CCFL) or an external electrode fluorescent lamp (EEFL).

3. The liquid crystal display module of claim 1 wherein the light converting unit comprises:
a light converting plate that converts Y-directional polarized light into X, Y-double directional polarized lights; and
a reflect sheet that reflects the light reflected from the wire grid polarizing plate back to the wire grid polarizing plate.

4. The liquid crystal display module of claim 1 wherein the light converting unit is formed on the lower portion of the wire grid polarizing plate.

5. The liquid crystal display module of claim 1, wherein the light source unit is formed of a light-emitting type electroluminescence (EL) element.

6. The liquid crystal display module of claims 1, wherein the light converting plate is formed between the reflecting sheet and the wire grid polarizing plate to refract light reflected from the wire grid polarizing plate and light reflected from the reflecting sheet.

7. The liquid crystal display module of claim 6, wherein the light converting plate is formed of a material having a refraction index more than the refraction index of air, and differing from the refraction index of the wire grid polarizing plate.

8. The liquid crystal display module of claim 1, wherein the wire grid polarizing plate comprises:
a transparent substrate;
a light reflecting layer disposed between transmission holes formed on the transparent substrate; and
an insulating film formed on the transparent substrate to cover the light reflecting layer and the transparent substrate,

9. The liquid crystal display module of claim 8, wherein the light reflecting layer is formed from a metal group consisting of Al, Cr, Mo, Ag, Cu, and Au, or an opaque polymer material.

10. The liquid crystal display module of claim 8, wherein the transmission hole has a width less than the wavelength of a visible ray.

11. The liquid crystal display module of claim 8, wherein the transmission hole has a width of about 100˜300 nm.

12. The liquid crystal display module of claim 8, wherein the light reflecting layer has the same width as a width of the transmission hole.

13. The liquid crystal display module of claim 8, wherein the light reflecting layer has a width more than the width of the transmission hole by about 20%.

14. The liquid crystal display module of claim 8, wherein the light reflecting layer is shaped in one of stripe, curve, chevron, or matrix.

15. The liquid crystal display module of claim 8, wherein a light reflecting film of the wire grid polarizing plate is formed by a laser beam radiation method or a photolithography method.

16. The liquid crystal display module of claim 1, wherein the LCD panel comprises:
a thin film transistor (TFT) substrate having a plurality of TFTS;
a countering substrate facing the TFT substrate:
a liquid crystal layer interposed with the TFT substrate and the countering substrate; and
an upper phase difference film formed on the front side of the countering substrate.

17. The liquid crystal display module of claim 16, wherein the LCD panel further comprises a lower phase difference film formed on the back side or the front side of the TFT substrate.

18. The liquid crystal display module of claim 16, wherein the lower is phase difference film is formed to cover the TFT

19. The liquid crystal display module of claim 17, wherein the wire grid polarizing plate is affixed to the lower phase difference film.

20. The liquid crystal display module of claim 17, wherein the wire grid polarizing plate is spaced apart from the lower phase difference film,
